(19) United States
(12) Patent Application Publication
(10) Pub. No.: US 2006/0286380 A1
(43) Pub. Date: Dec. 21, 2006

(54) Components with bearing or wear-resistant surfaces

(75) Inventors: Christopher John Howard Wort, Oxfordshire (GB); Mark Robin McClymont, Berkshire (GB)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: DIAMANX PRODUCTS LIMITED, Isle of Man (GB)

(21) Appl. No.: 11/476,093

(22) Filed: Jun. 28, 2006

Related U.S. Application Data
(63) Continuation of application No. 10/486,199, filed on Jun. 28, 2004, now abandoned.

(30) Foreign Application Priority Data
Aug. 16, 2001 (GB) 0120037.7

(51) Int. Cl. B32B 9/00; B32B 19/00

(52) U.S. Cl. 428/408; 428/698

(57) ABSTRACT

A component comprises a silicon carbide substrate (10), a layer (14) of CVD diamond on a surface (12) of the substrate, and a smooth surface (14a) on the CVD diamond layer (14) which is a non-planar bearing or wear-resistant surface for the component.

### BACKGROUND OF THE INVENTION

This invention relates to components with bearing or wear-resistant surfaces.

Ceramics such as silicon carbide can be fabricated in bulk form and shaped into various structures such as tubes, balls, and the like. Such structures will present planar, curved or otherwise profiled surfaces. Although silicon carbide is strong and tough, it still wears when used as a bearing or bush material. Silicon carbide also has a high co-efficient of friction when sliding against itself or against many other materials. These problems have limited the use of silicon carbide as a three-dimensional bearing or bush material.

U.S. Pat. No. 5,645,601 describes a prosthetic ball and socket joint wherein the contacting surfaces of the ball and the socket are provided with a coating of polycrystalline diamond. The polycrystalline diamond coatings are formed by bonding a layer of polycrystalline diamond compact to the load-bearing or contacting surfaces of the ball and socket by sintering at high temperature and pressure, high temperature laser application, electroplating, chemical vapour deposition or forming a matrix with a high molecular weight polyethylene.

Polycrystalline diamond compact are produced under high temperature and pressure conditions. Such compacts contain direct diamond-to-diamond bonding and generally contain a bonding or second phase. Such bonding or second phase will typically be, or contain, a diamond solvent/catalyst such as cobalt, iron or nickel.

In producing the coated load-bearing surface, the polycrystalline diamond compact has first to be made, shaped to complement the shape of the load-bearing surface to which is to be applied and thereafter bonded to that surface. Difficulties which arise are first the shaping of the diamond compact which is a very hard material and second, ensuring that a good bond is produced between the load-bearing surface and the diamond compact.

EP 540366 describes a tool insert which comprises a diamond layer bonded to a surface of a silicon carbide substrate. The diamond layer is preferably CVD diamond. The diamond layer has a flat planar portion which may be polished leading to a cutting edge. One of the purposes of polishing the planar portion of the diamond layer is to improve the cutting edge sharpness.

U.S. Pat. No. 5,298,285 describes a method of making a tool component which comprises a CVD diamond layer bonded to a cemented carbide substrate. The cemented carbide substrate in the tool component comprises a mass of carbide particles bonded into a coherent form by a metal binder such as cobalt, iron or nickel.

CVD diamond is diamond produced by chemical vapour deposition. Such diamond may be polycrystalline or single crystal in nature and may be grown on various substrates using methods well known in the art.

### SUMMARY OF THE INVENTION

According to the present invention, a component comprises a silicon carbide substrate, a layer of CVD diamond on a surface of the substrate and a smooth non-planar surface on the CVD diamond layer which is a bearing or wear-resistant surface for the component. Typically, the surface of the substrate on which the CVD diamond layer is provided is non-planar and preferably has essentially the same shape as the smooth non-planar surface on the CVD diamond layer.

The substrate is a silicon carbide substrate. The silicon carbide may be single crystal or polycrystalline. Silicon carbide, in particular polycrystalline silicon carbide, is now a mature technical engineering material and may be made by several methods known in the art. These methods include chemical vapour deposition CVD, hot isostatic pressing (HIP), reaction bonded (RB) and direct sinter (DS) methods.

Silicon carbide is a ceramic which can be readily shaped to provide various profiled surfaces on which the CVD diamond layer may be provided. The silicon carbide substrate is refractory and mechanically tough and provides mechanical strength and support for the CVD diamond layer. It also has a thermal conductivity which is sufficiently high to assist in keeping the CVD diamond layer cool and a thermal expansion coefficient similar to CVD diamond. This means that the silicon carbide/diamond interface is not excessively stressed by differential thermal expansion stresses on cooling from synthesis temperatures. Thus, a surface, i.e. a non-planar surface, of silicon carbide can be readily coated with CVD diamond, which then adheres extremely well to the silicon carbide surface. Tungsten carbide, an alternative hard substrate material, is limited in this application because it contains free cobalt which prevents the diamond layer from adhering properly. In addition, free heavy metals such as cobalt are not considered biocompatible or allowed in the body as they are generally considered toxic.

A layer of CVD diamond is provided on a surface of the substrate. This layer may be synthesised directly on to that surface. Such methods, as described above, are well known in the art and enable the CVD diamond layer to be formed and bonded directly to the surface to which it is applied. Effective bonding takes place without the need for any separate and independent bonding medium. Thus, it is preferred that the CVD diamond layer is bonded directly to a surface of the substrate to which it is applied.

It is possible for the CVD diamond layer to be produced independently and then bonded, for example by brazing, to a surface of the substrate. Any suitable metal braze known in the art may be used in this regard.

The layer of CVD diamond layer presents a smooth surface. The smoothness of the surface will depend on the application to which the body is to be put and will typically have an Rₐ roughness of less than 40 nm. The smooth surface may be polished, particularly when that surface is to be used as a bearing surface.

The CVD diamond layer has or presents a smooth non-planar surface, which will typically be curved. Although it is common practice to smooth or polish a planar CVD diamond surface, the smoothing of non-planar CVD diamond surfaces is far more difficult. Several methods have been devised to smooth non-planar diamond surfaces including mechanical grinding, lapping, sputter etching, reactive ion etching and laser ablation. Planar surfaces must maintain a high level of “flatness” after smoothing or planarisation. Similarly, non-planar surfaces must also retain the required geometrical tolerances, when smoothed or polished. The preferred method of smoothing a non-planar surface depends entirely on the geometry of that surface.

The component may define an article such as a ball, tube or rod. In this form of the invention, the silicon carbide substrate will define the article and a surface of that article will be provided with a layer of CVD diamond.

The component may form part of, or be adapted to form part of, a larger article. For example, the silicon carbide substrate may be a layer, typically a free standing layer, having a layer of CVD diamond bonded to a surface thereof. Thus, the component in this form of the invention will be a bi-layer which may be attached to another body to provide that body with a bearing or wear-resistant surface. The silicon carbide layer will typically have a thickness greater than 200 μm. The silicon carbide is readily bondable to metal and other such bodies. In this form of the invention, the silicon carbide layer will generally be thicker than the CVD diamond layer.

### BRIEF DESCRIPTION OF THE DRAWINGS

FIG. 1 is a sectional side view of an embodiment of a ball bearing of the invention,

FIG. 2 is a perspective view of an embodiment of a tube of the invention,

FIG. 3 is a perspective view of an embodiment of a ball and socket of the invention, and

FIG. 4 is a perspective view of a second embodiment of a ball and socket of the invention.

### DESCRIPTION OF EMBODIMENTS

The silicon carbide provides mechanical strength and support for the CVD diamond layer and has a high thermal conductivity to assist in keeping the CVD diamond layer cool. The CVD diamond layer presents a smooth surface which provides an abrasion and wear-resistant surface and a surface of low coefficient of friction. Further, the CVD diamond layer is an effective heat spreader for local hot spots which may develop in use.

The CVD diamond may be single crystal or polycrystalline in nature The outer exposed surface of the CVD diamond layer will be smooth, preferably polished, particularly when the surface is to be used as a bearing surface.

The CVD diamond layer will typically have a thickness in the range 1-100 μm.

The silicon carbide of the substrate may be enriched in silicon as is known in the art, such that the concentration of silicon exceeds stoichiometry and there is present free silicon in the material which can render it electrically conductive. Such electrically conductive silicon carbide can be processed by electro-discharge machining (EDM). Furthermore, by doping the CVD diamond with boron or other dopant, the CVD diamond layer can also be rendered electrically conductive, making the diamond/silicon carbide assembly suitable for EDM cutting, shaping or surface processing.

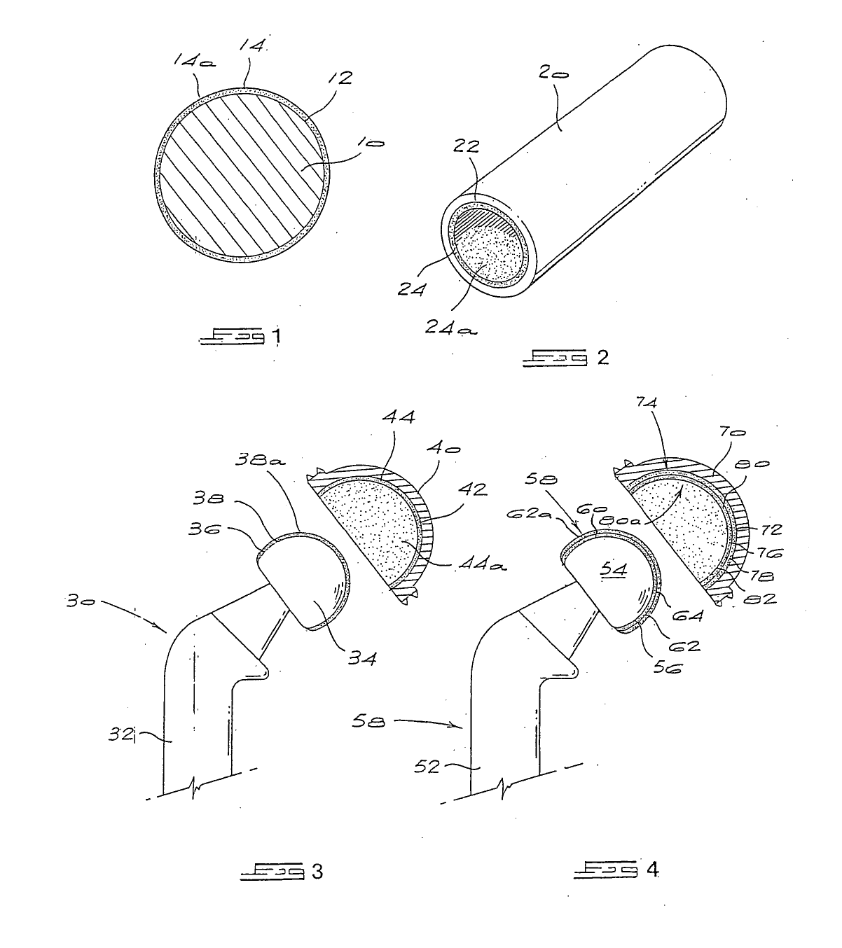

The component of the invention has particular application for situations where bearing or wear-resistant surfaces are required with high chemical inertness, low coefficient of friction, low wear rates, high hardness, abrasion resistance and good biocompatibility. Particular examples of components of the invention are:
1. Silicon carbide balls such as ball bearings, coated on the outside with a layer of CVD diamond, which is then smoothed. An example of such a ball is illustrated by FIG. 1. Referring to this figure, a silicon carbide ball 10 has an outer surface 12 to which a layer 14 of CVD diamond is applied. The layer 14 of CVD diamond covers the outer surface 12 of the ball 10 entirely.
2. Silicon carbide tubes coated on the inside with a CVD diamond layer which may then be smoothed or polished for sliding seals, bushes such as valve guides, cylinder barrels such as those used in engines, and pipes for corrosive or abrasive fluids. An example of a silicon carbide tube coated on the inside with a CVD diamond layer is illustrated by FIG. 2. Referring to this figure, the silicon carbide tube 20 has an inner surface 22 which is entirely coated with a CVD layer 24.
3. Silicon carbide tubes or rods coated on the outside surface with a layer of CVD diamond which may be polished for use as bearing rollers, sliding seals, pistons, cam shafts or bush rods.
4. Ball and socket joints, such as hip joints. Either the ball or the socket or both the ball and the socket may be made of silicon carbide with the bearing surface of either the socket or the ball or both being coated with a layer of CVD diamond, which is then smoothed. Examples of such ball and socket joints are illustrated by FIGS. 3 and 4.
Referring first to FIG. 3, the ball component of the joint is illustrated by 30 and comprises a stem 32 having at one end a ball component 34. The outer rounded surface 36 of the ball component 34 is provided with a layer 38 of CVD diamond. Complemental socket 40 has a round inner surface 42 which is provided with a layer 44 of CVD diamond. In this form of the invention, the ball component 34 and the socket 40 are both made of silicon carbide.
A second embodiment of a ball and socket joint is illustrated by FIG. 4. Referring to this figure, the ball component 50 comprises a stem 52 having at one end thereof a ball component 54. The stem 52 and ball component 54 are both made of a metal such as stainless steel. The outer surface 56 of the ball component 54 has a bi-layer 58 bonded to it. The bi-layer 58 consists of an inner layer 60 consisting of silicon carbide bonded to the surface 56 and an outer layer 62 of CVD diamond bonded to the surface 64 of the silicon carbide layer 60. A complemental socket 70 is also made of a metal such as stainless steel. The inner surface 72 of the socket 70 has a bi-layer 74 bonded to it. The bi-layer has a layer 76 of silicon carbide bonded to the surface 78 of the socket and a layer 80 of CVD diamond bonded to the surface 82 of the layer 76.
In the above described ball and socket embodiments, it is possible to combine or interchange various features of each embodiment. For example, the ball component may be provided with the bi-layer and the socket component may be made of silicon carbide to which is bonded a layer of CVD diamond to the inner surface thereof.
CVD diamond layers can be synthesised for this application to near net shape directly on to the silicon carbide substrate, requiring only polishing of the bearing surface. CVD diamond layers are pure diamond, not containing binder phases, enhancing their biocompatibility. In contrast, diamond compacts are not normally produced to near net shape but are thick discs from which components are fabricated, and are characterised by containing a binder phase. This binder phase in compacts generally contains cobalt which could be leached out within the body. Wear of a diamond compact surface is liable to generate metallic fragments from this binder phase, which would degrade biocompatibility further.
5. Silicon carbide non-symmetric components such as cams having a layer of CVD diamond, smoothed or polished, applied to a portion or the entire outer surface thereof.

In the embodiments illustrated by FIGS. 1 to 4 and as described above, it will be the outer exposed surface of the CVD diamond layer which provides the bearing or wear-resistant surface for the component and which will be smooth. Thus, in the case of FIG. 1, it is the outer exposed surface 14a, in FIG. 2 the inner exposed surface 24a, in FIG. 3 the outer exposed surface 38a of the ball component and inner surface 44a of the socket, and in FIG. 4 the outer exposed surface 62a of the ball component and the inner exposed surface 80a of the socket.

In the embodiments described above, it is preferable that the CVD diamond layer is grown directly on a surface of the silicon carbide substrate. This is particularly so in the case of hip joints.

Smoothing or polishing of the bearing or wear-resistant surfaces of the CVD diamond layers may be achieved by any one of the methods described above. Examples of two methods of smoothing such surfaces will now be described.

### EXAMPLE 1

Smoothing of the outside of a coated cylindrical sample where the cylinder has a centre of rotation about its central axis.

In this case the coated sample is mounted on a spindle such that the spindle passes through the centre of rotation of the sample. The sample is then rotated about the spindle at a suitable speed whilst pressed against a diamond abrasive medium, which in turn may itself be rotated or translated about another axis. The diamond abrasive medium for effecting the smoothing may be a steel plate covered with a diamond slurry or a resin bonded wheel that contains diamond particles. The abrasive diamond particles are selected such that the exposed curved CVD diamond surface is smoothed. To yield a polished product or one with a controlled surface roughness, it may be necessary to repeat the process several times using progressively smaller abrasive diamond particles.

### EXAMPLE 2

Smoothing a spherical segment of a CVD diamond coated silicon carbide ball

In this case, the sample is mounted on a spindle such that the ball can be rotated about two orthogonal axes of rotational symmetry. The ball is spun around one axis and moved around the other whilst being pressed against abrasive diamond medium, as described in Example 1. In this way, the rough CVD diamond surface is smoothed whilst being generated into an accurate spherical geometry by virtue of the ball mounting.

We claim

1. A component comprising a silicon carbide substrate, a layer of CVD diamond on a surface of the substrate and a smooth non-planar surface on the CVD diamond layer which is a bearing or wear-resistant surface for the component.

2. A component according to claim 1 wherein the layer of CVD diamond is bonded directly to the surface of the substrate to which it is applied.

3. A component according to claim 1 wherein the smooth surface of the CVD diamond layer has an Rₐ roughness of less than 40 nm.

4. A component according to claim 1 wherein the silicon carbide substrate is a layer of silicon carbide.

5. A component according to claim 4 wherein the silicon carbide layer is thicker than the CVD diamond layer.

6. A component according to claim 4 wherein the layer of silicon carbide has a thickness exceeding 200 μm.

7. A component according to claim 1 wherein the CVD diamond layer has a thickness in the range 1 to 100 μm.

8. A component according to claim 1 wherein the surface of the substrate on which the CVD diamond layer is provided is non-planar.

9. A component according to claim 8 wherein the surface of the substrate on which the CVD diamond layer is provided has essentially the same shape as the smooth non-planar surface on the CVD diamond layer.

10. A component according to claim 1 wherein the bearing or wear-resistant surface is a curved surface.

11. A component according to claim 1 wherein the silicon carbide substrate is a ball having a layer of CVD diamond coated on the outside surface thereof.

12. A component according to claim 1 wherein the silicon carbide substrate is a tube having a layer of CVD diamond coated on the inside surface thereof.

13. A component according to claim 1 wherein the silicon carbide substrate is a tube or rod having a layer of CVD diamond coated on the outside surface thereof.

14. A component according to claim 1 which is a ball of a ball and socket joint, the bearing surface of the ball being provided by the CVD diamond layer.

15. A component according to claim 1 wherein the component is a socket for a ball and socket joint, the bearing surface of the socket being provided by the CVD diamond layer.
